(19) United States
(12) Patent Application Publication
(10) Pub. No.: US 2024/0163914 A1
(43) Pub. Date: May 16, 2024

(54) METHODS AND APPARATUSES FOR SMALL DATA TRANSMISSIONS IN INACTIVE STATE

(71) Applicant: Nokia Technologies Oy, Espoo (FI)

(72) Inventors: Nuno Manuel KIILERICH PRATAS, Aalborg (DK); Daniela LASELVA, Aalborg (DK); Sofonias HAILU, Oulu (FI)

(21) Appl. No.: 18/550,259

(22) PCT Filed: Mar. 3, 2022
(86) PCT No.: PCT/EP2022/055340

§ 371 Date: Sep. 12, 2023

(30) Foreign Application Priority Data
Mar. 23, 2021 (FI) 20215323

(51) Int. Cl. H04W 72/542; H04W 72/044

(52) U.S. Cl. CPC H04W 72/542; H04W 72/046

(57) ABSTRACT

An apparatus for use by a communication element or function configured to act as a communication element or function in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to obtain (S240) a first set of metrics indicating at least one of a signal level and a signal quality of at least one beam associated with the communication network, to obtain (S440), before a small data transmission is conducted, a second set of metrics indicating at least one of a signal level and signal quality of at least one beam associated with the communication network, to conduct (S450) a validation processing for determining whether a timing advance setting is valid, wherein the determination is based on the obtained first set of metrics and the obtained second set of metrics and a preset rule related to at least one beam related to the communication network, and to select a small data transmission mode on the basis of a result of the validation processing.

### BACKGROUND

### Field

Examples of embodiments relate to apparatuses, methods, systems, computer programs, computer program products and (non-transitory) computer-readable media usable for enabling small data transmission when a communication element or function, such as a user equipment, is in an inactive state, and in particular to apparatuses, methods, systems, computer programs, computer program products and (non-transitory) computer-readable media usable for enabling small data transmission of a user equipment being in an inactive state such as an RRC INACTIVE state according to 3GPP standards when an intra-beam movement of the user equipment is considered.

### BACKGROUND ART

The following description of background art may include insights, discoveries, understandings or disclosures, or associations, together with disclosures not known to the relevant prior art, to at least some examples of embodiments of the present disclosure but provided by the disclosure. Some of such contributions of the disclosure may be specifically pointed out below, whereas other of such contributions of the disclosure will be apparent from the related context.

WO2021030804 A1 considers reception of a random access response and presents that a wireless device transmits a first preamble via a cell. The wireless device receives a downlink grant for a random access response. The wireless device determines a failure to receive the random access response. The wireless device determines, based on the failure and a time alignment timer of the cell, an uplink signal for transmission via the cell. The uplink signal is one of a second preamble and a negative acknowledgement. The wireless device transmits the uplink signal.

Qualcomm incorporated presents in R2-2101233, 3GPP TSG-RAN WG2 Meeting #113e Online, January 25^{th}-February 5^{th}, a discussion on CG based NR small data transmission.

ZTE Corporation presents in R2-2009190, 3GPP TSG-RAN2 #112e, 02-13 Nov. 2020, control plane aspects of SDT.

Ericsson presents in R4-1906795, 3GPP TSG-RAN WG4 Meeting #91, Reno, United States of America, 13-17 May, 2019, discussions on RRM requirements for transmissions using PUR for NB-IoT.

Rapporteur (ZTE) presents in R3-210192, 3GPP TSG-RAN WG3 #111-e, 25 Jan.-4 Feb. 2021, discussions on support of small data transmission in inactive state.

The following meanings for the abbreviations used in this specification apply:
3GPP 3^{rd} Generation Partnership Project
4G fourth generation
5G fifth generation
5GS 5G system
AP access point
BS base station
CG configured grant
CPU central processing unit
CS configured scheduling
DCI downlink control information
DL downlink
EDT early data transmission
eNB E-UTRAN Node B
ETSI European Telecommunications Standards Institute
gNB next generation node B
GPRS general packet radio service
ID identification
IoT Internet of things
LTE Long Term Evolution
LTE-A LTE Advanced
NB narrow band
NF network function
NG new generation
NW network, network side
PCG preconfigured grant
PDCCH physical downlink control channel
PSS primary synchronization signal
PUR periodic uplink resources
PUSCH physical uplink shared channel
RA random access
RACH random access channel
RAN radio access network
RNTI radio network temporary identifier
RRC radio resource control
SDT small data transmission
SI system information
SIB system information block
SSB synchronization signal block
SSS secondary synchronization signal
TA timing advance
TDOA time difference of arrival
UE user equipment
UL uplink
UMTS universal mobile telecommunication system

### SUMMARY

According to an example of an embodiment, there is provided, for example, an apparatus for use by a communication element or function configured to act as a communication element or function in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to obtain a first set of metrics indicating at least one of a signal level and a signal quality of at least one beam associated with the communication network, to obtain, before a small data transmission is conducted, a second set of metrics indicating at least one of a signal level and signal quality of at least one beam associated with the communication network, to conduct a validation processing for determining whether a timing advance setting is valid, wherein the determination is based on the obtained first set of metrics and the obtained second set of metrics and a preset rule related to at least one beam related to the communication network, and to select a small data transmission mode on the basis of a result of the validation processing.

Furthermore, according to an example of an embodiment, there is provided, for example, a method for use in a communication network element or function configured to act as a communication element or function in a communication network, the method comprising obtaining a first set of metrics indicating at least one of a signal level and a signal quality of at least one beam associated with the communication network, obtaining, before a small data transmission is conducted, a second set of metrics indicating at least one of the signal level and the signal quality of at least one beam associated with the communication network, conducting a validation processing for determining whether a timing advance setting is valid, wherein the determination is based on the obtained first set of metrics and the obtained second set of metrics and a preset rule related to beams of the at least one beam associated with the communication network, and selecting a small data transmission mode on the basis of a result of the validation processing.

According to further refinements, these examples may include one or more of the following features:
from an access network control element or function, there may be received configuration information of settings for obtaining the metrics indicating the at least one of the signal level and the signal quality of the at least one beam associated with the communication network, including an indication allowing to determine beams to be measured, and settings for conducting the validation processing, and setting for small data transmission indicating resources to be used for the small data transmission according to a selected small data transmission mode, wherein the received configuration information may be processed;
results of the obtaining of the first set and second set of metrics indicating the at least one of the signal level and the signal quality of the at least one beam associated with the communication network may be stored in association with an identification of the at least one beam being measured;
as the first set of metrics, metrics indicating the at least one of the signal level and the signal quality of a serving beam and of non-serving beams may be obtained, and, as the second set of metrics, metrics indicating the at least one of the signal level and the signal quality of the serving beam or a default beam and of non-serving beams may be obtained, wherein the non-serving beams may comprise one of a predetermined number of non-serving beams having the strongest signal strength compared to other non-serving beams, a set of non-serving beams having a signal strength being above a predetermined threshold, a set of non-serving beams being identified by the communication network;
the first set of metrics indicating the at least one of the signal level and the signal quality of the at least one beam associated with the communication network may be obtained when the communication element or function is in an inactive radio resource control state having a valid timing advance setting for communicating with a serving access network control element or function;
as the small data transmission mode, a configured grant small data transmission may be selected when the result of the validation processing indicates that a valid timing advance setting is present, and, as the small data transmission mode, to conduct a random access procedure for the small data transmission may be selected when the result of the validation processing indicates that no valid timing advance setting is present;
before obtaining the second set of metrics, it may be checked whether a signal level or a signal quality of a serving beam fulfills a validity condition for a small data transmission in an inactive connection state, and in case the check whether the signal level or signal quality of the serving beam fulfills the validity condition for a small data transmission in an inactive connection state, is negative, a random access procedure for a small data transmission may be conducted;
the metrics indicating the at least one of the signal level and the signal quality of the at least one beam associated with the communication network may comprise at least one of a reference signal receiving power value and a reference signal receiving quality value obtained for the at least one beam associated with the communication network;
the metrics indicating the at least one of the signal level and the signal quality of the at least one beam associated with the communication network may be at least one of beam related values and cell related values, wherein the values may be related to at least one of a serving beam, a default beam and non-serving beams having the strongest signal strength;
the preset rule for conducting the validation processing may comprises at least one of a comparison of identifications of serving beams in the first set of metrics and the second set of metrics, a comparison of identifications of sets of beams in the first set of metrics and the second set of metrics, a comparison of variations of obtained metrics of individual beams with a predetermined first threshold, a comparison of variations of obtained metrics of paired beams with a predetermined second threshold, a comparison of obtained metrics of non-serving beams with a predetermined third threshold;
the communication network may be based on a 3GPP standard.

According to an example of an embodiment, there is provided, for example, an apparatus for use by a communication network control element or function configured to act as an access network control element or function controlling a communication of a communication element or function in a communication network, the apparatus comprising at least one processing circuitry, and at least one memory for storing instructions to be executed by the processing circuitry, wherein the at least one memory and the instructions are configured to, with the at least one processing circuitry, cause the apparatus at least: to prepare and send, to the communication element or function being served, configuration information of settings for obtaining metrics indicating at least one of a signal level and a signal quality of at least one beam associated with the communication network, including an indication allowing to determine beams to be measured, and for conducting a validation processing for determining whether a timing advance setting of the communication element or function is valid, wherein the determination is based on the obtained metrics and a preset rule related to at least one beams associated with the communication network, and settings for small data transmission indicating resources to be used by the communication element or function for a small data transmission according to a small data transmission mode to be selected according to the validation processing.

Furthermore, according to an example of an embodiment, there is provided, for example, a method for use in a communication network control element or function configured to act as an access network control element or function controlling a communication of a communication element or function in a communication network, the method comprising preparing and sending, to the communication element or function being served, configuration information of settings for measuring metrics indicating at least one of a signal level and a signal quality of at least one beam associated with the communication network, including an indication allowing to determine beams to be measured, and for conducting a validation processing for determining whether a timing advance setting of the communication element or function is valid, wherein the determination is based on the obtained metrics and a preset rule related to at least one beam associated with the communication network, and settings for small data transmission indicating resources to be used by the communication element or function for a small data transmission according to a small data transmission mode to be selected according to the validation processing.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present disclosure are described below, by way of example only, with reference to the accompanying drawings, in which:

FIG. 1 shows a diagram illustrating an example of a scenario in a communication network in which examples of embodiments are implementable;

FIG. 2 shows a diagram showing a RRC state machine and RRC state transitions;

FIGS. 3A and 3B show signaling diagrams explaining examples of configured grant types;

FIG. 4 shows a signaling diagram of a SDT processing according to some examples of embodiments;

FIG. 5 shows a flow chart of a processing conducted in a communication element according to some examples of embodiments;

FIG. 6 shows a flow chart of a processing conducted in an access network control element or function according to some examples of embodiments;

FIG. 7 shows a diagram of a network element or function representing a communication element or function according to some examples of embodiments; and

FIG. 8 shows a diagram of a network element or function representing an access network control element or function according to some examples of embodiments.

### DESCRIPTION OF EMBODIMENTS

In the last years, an increasing extension of communication networks, e.g. of wire based communication networks, such as the Integrated Services Digital Network (ISDN), Digital Subscriber Line (DSL), or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on Long Term Evolution (LTE) or Long Term Evolution-Advanced (LTE-A), fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

In wireless communication systems, such as in cellular systems, timing advance (TA) is a concept used to compensate for propagation delay differences of communication elements, such as UEs or the like (to be specified below), being at different distances from an access network station, such as a base station, gNB or the like.

When time multiplexing different UEs, it is important that a UE being farther away from the base station does not have the end of its transmission burst overlap with the start of another UE that is next to transmit and is closer to the base station. Therefore, the UE being farther away is requested or set by the network so as to ‘advance’ its UL transmission in time relative to its observed DL time.

In systems relying in orthogonal subcarriers and cyclic prefix (e.g. systems like LTE and NR), frequency multiplexing of two UL transmissions would need to be seen as received at (almost) same timing. Therefore, also in such systems, similar to the time multiplexing example indicated above, a TA adjustment is used to compensate for propagation delay differences.

As can be easily understood, in wireless communication scenarios, such as in examples as described above, transmissions with incorrect TA setting can cause problems to the receiving side, such as a base station.

With the introduction of new communication systems, such as 3GPP based 5G systems, or NR system, the performance of telecommunications shall be improved. For example, NR systems support a connection state referred to as RRC_INACTIVE state. UEs with infrequent (periodic and/or non-periodic) data transmission are generally maintained by the network in the RRC_INACTIVE state.

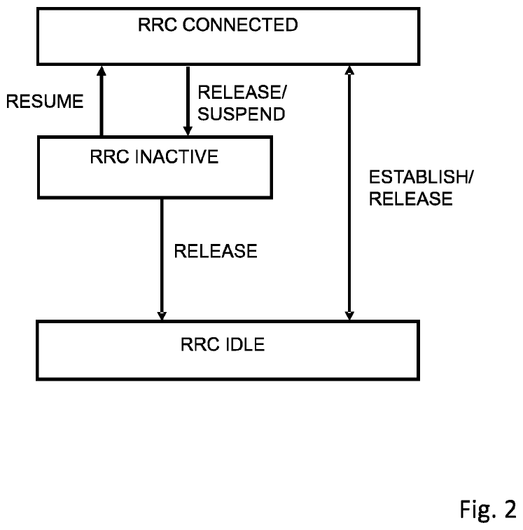

FIG. 2 illustrates an overview of UE RRC state machine and state transitions within NR. It is to be noted that a UE has only one RRC state in NR at one time.

As shown in FIG. 2, for example, three states are assumed, i.e. RRC_CONNECTED state, RRC_INACTIVE state (which belong to a connection management state referred to as “connected”) and RRC_IDLE state (which belong to a connection management state referred to as idle).

Among these states, RRC_INACTIVE is introduced in 3GPP NR with the goal of lean signaling and energy-efficient support of NR services. Although, the design was conceived particularly for mMTC/MIoT services, it is also beneficial to efficiently deliver small/infrequent traffic of eMBB and URLLC services.

In FIG. 2, the arrow “resume” between the RRC_INACTIVE and RRC_CONNECTED state indicates a situation in a data transfer case. The same applies for the arrow “establish” between the RRC_IDLE and RRC_CONNECTED state. The arrow “release/suspend” between the RRC_INACTIVE and RRC_CONNECTED state indicates a, RRC state transition e.g. due to timer expiry or inactivity. The arrow “release” between the RRC_INACTIVE and RRC_IDLE state indicates a situation in an overload or failure case.

Generally, the transition from RRC_CONNECTED to RRC_INACTIVE is triggered by the network side, e.g. a base station like a gNB, with the transmission of an RRC release message that includes suspend configuration information (which includes inactive-RNTI (I-RNTI), RAN-PagingCycle, RAN-NotificationAreaInfo and timer information.

The RRC_INACTIVE state enables to quickly resume the connection and start the transmission of small or sporadic data with a much lower initial access delay and associated signaling overhead as compared to the RRC_IDLE state. This is achieved mainly, thanks to reduced control signaling required for requesting and obtaining the resume of a suspended RRC connection, which results in UE power saving. At the same time, a UE in RRC_INACTIVE is able to achieve similar power savings as in RRC_IDLE, benefiting from e.g. a much larger period of PDCCH monitoring (e.g. paging) and relaxed measurements compared to RRC_CONNECTED. Furthermore, compared to keeping the UE in RRC_CONNECTED, the new state minimizes mobility signaling both to RAN (e.g. RRC measurement reporting, handover messages) and to the core network. When a UE is moved to RRC_INACTIVE via an RRC Connection Suspend message, the UE Access Stratum (AS) context (referred to as UE Inactive AS Context), necessary for the quick start of the connection, is maintained both at the UE side and RAN side, and it is identified by the UE identifier, i.e. I-RNTI.

Examples of small and infrequent data traffic include, for example, smartphone applications, such as traffic from Instant Messaging services (whatsapp, QQ, wechat etc.), heart-beat/keep-alive traffic from email clients and other applications, push notifications from various application, but also non-smartphone applications, such as traffic from wearables (periodic positioning information etc.), sensors (Industrial Wireless Sensor Networks transmitting temperature, pressure readings periodically or in an event triggered manner etc.), smart meters and smart meter networks sending periodic meter readings.

Amongst others, as one set of targets, NR systems shall be efficient and flexible for low throughput short data bursts, support efficient signaling mechanisms (e.g. signaling is less than payload), and reduce signaling overhead in general. Small data transmissions in INACTIVE state of NR allow to avoid signaling overhead and delay associated with transition from RRC_INACTIVE to RRC_CONNECTED to perform a short data transmission. This functionality is important, since the motivation to introduce the RRC_INACTIVE state was, as described above, to be able to transition UEs with infrequent data transmission to a state with minimum signaling overhead and power consumption.

Signaling overhead from INACTIVE state UEs for small data packets is a general problem and will become a critical issue with more UEs in NR not only for network performance and efficiency but also for the UE battery performance. In general, any device that has intermittent small data packets in INACTIVE state will benefit from enabling small data transmission in INACTIVE state.

As key enablers for small data transmission in NR, the INACTIVE state described above, 2-step, 4-step RACH and configured grant (CG) type 1 have been identified as building blocks to enable small data transmission. That is, for example, for a SDT using the 2-step RACH (i.e. 2-step RA SDT), MsgA PUSCH may be used to transmit the SDT payload. For a SDT using the 4-step RACH (i.e. 4-step RA SDT), Msg3 (PUSCH) may be used to transmit the SDT payload. On the other hand, for SDT using UL data transmission on pre-configured PUSCH resources (i.e. CG-SDT), Configured Grant-based resources of type 1 can be used by the UE to transmit the SDT payload when it has a valid TA.

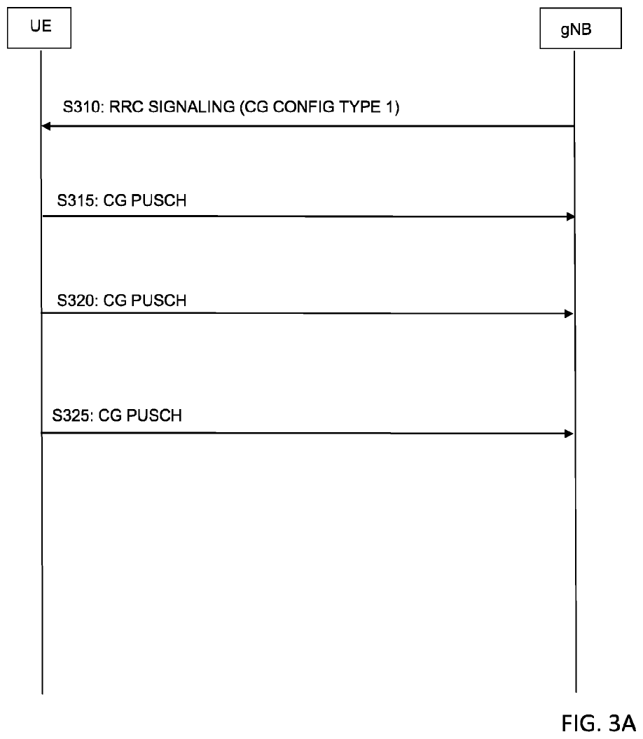

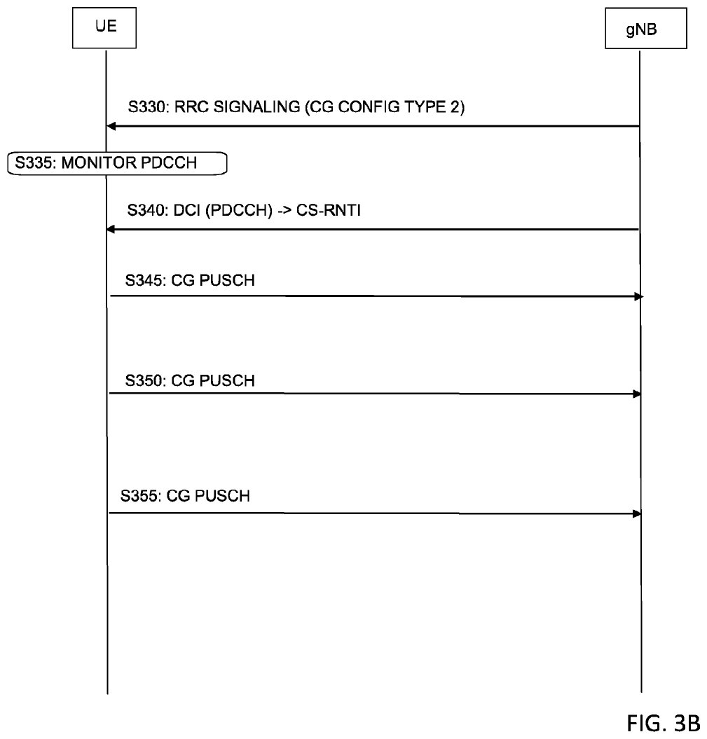

With regard to the CG and the CG PUSCH resources used in this regard, the following is to be noted. In communication network such as NR it is possible to configure UL transmissions without the need to transmit a dynamic grant in correspondence of each UL transmission occasion. The configuration of these UL resources, also referred to as Configured Grant (CG) PUSCH resources, can happen according to two possible schemes illustrated in FIGS. 3A and 3A.

FIG. 3A shows a signaling diagram illustrating a configured (UL) grant type 1 processing between a UE as a communication element or function and a gNB as a communication network control element or function.

In S310, the actual UL grant is configured via RRC signaling from the gNB to the UE The RRC signaling includes e.g. periodicity and starting time(s) of UL transmissions.

S315, S320 and S325 indicate corresponding UL transmissions via CG PUSCH from the UE to the gNB.

FIG. 3B, on the other hand, shows a signaling diagram illustrating a configured (UL) grant type 2 processing between a UE as a communication element or function and a gNB as a communication network control element or function.

In S330, UL grant is configured via RRC signaling from the gNB to the UE The RRC signaling includes e.g. periodicity, but not starting time(s) of UL transmissions. In S335, the UE monitors PDCCH as the actual starting time for UL transmission is triggered via the PDCCH. In S340, gNB provides the UE with information via PDCCH addressed to CS-RNTI for designating the starting time.

S345, S350 and S355 indicate corresponding UL transmissions via CG PUSCH from the UE to the gNB.

As indicated above, for SDT in NR, it is assumed that a UE being in RRC_INACTIVE state uses, for example, for the transmission of small data in the UL direction pre-configured PUSCH resources (i.e. reusing the configured grant type 1) wherein a TA setting is valid. For example, a data volume threshold is used by the UE to decide whether to conduct SDT or not.

However, it may be a problem to maintaining a valid timing advance or time alignment so as to enable SDT using such preconfigured resources, thus extending the usage of the UE's PCG-SDT.

With regard to TA validity criteria to be applied by the UE before attempting a CG based SDT transmission, the following is to be noted.

For maintaining TA setting, a specified TA timer for configured grant based SDT in RRC_INACTIVE can be introduced. The TA timer may be configured together with the CG configuration in the RRC signaling, e.g. in RRC release message from the gNB to the UE.

The UE can use CG SDT if, for example, at least the following criteria is fulfilled: (1) user data is smaller than the data volume threshold; (2) a CG resource is configured and valid; (3) the UE has valid TA setting.

However, the TA timer by itself may be not enough to validate if the UE still has a valid timing advance (TA), since the configured timer duration does not reflect the UE's mobility conditions and therefore the UE can become time misaligned before the TA timer expires. On the other hand, the UE may be still time aligned when the TA timer expires.

In PUR used, for example, for NB-IOT, the TA validation is made based on cell measured RSRP (L1-RSRP), specifically based on the difference of the RSRP value measured at the time a PUR transmission has to be made and the RSRP value measured at the time the UE has a valid TA (referred to as reference RSRP). Whenever the observed RSRP variation is above a configured delta increase/decrease thresholds, then the UE assumes that it no longer has a valid TA. Therefore, usage of PUR based transmissions is not possible.

However, the same RSRP based TA validation criteria is not sufficient in NR, mainly due to the characteristics associated with the NR's beam-based operation.

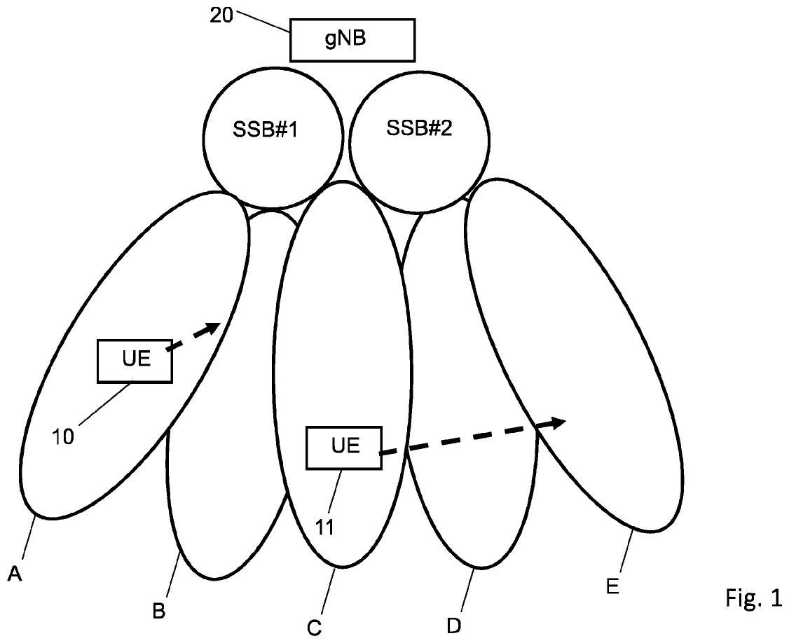

A corresponding operation example is illustrated in FIG. 1. FIG. 1 shows a diagram illustrating an example of a scenario in a communication network based on NR, for example, in which beam-based operation is implemented, wherein it is to be noted that FIG. 1 illustrates also an example where embodiments are implementable.

As shown in FIG. 1, a gNB 20 representing an access network control element or function several beams A to E illustrated by means of corresponding beams. The ellipses A to E represent SSB coverage projected to the ground. It is to be noted that the form and number of beams indicated in FIG. 1 is merely an example and can be varied. SSBs (i.e. SSB #1 and SSB #2) are allocated to different beams.

Furthermore, two UEs 10 and 11 are depicted in FIG. 1 as examples for communication elements of functions communicating in the network formed by the beams A to E. It is assumed that the UEs are movable, e.g. cell phones, wherein corresponding movement paths are exemplified by arrows in FIG. 1. Specifically, UE 10 is assumed to move within one beam, i.e. beam A (representing an example for an intra-beam movement), while UE 11 is assumed to move between different beams, i.e. beams C to E (representing an example for an inter-beam movement).

In the examples illustrated in FIG. 1, it is not possible for the UE to extract from the observation of the cell-level RSRP if the UE is still time aligned. With regard to UE (intra-beam movement example), the UE moves within the same SSB beam closer to the gNB 20 (reducing the pathloss), but farther away from the beamforming lobe (i.e. where the beamforming gain is the highest), which results on a net zero variation of the RSRP while there is a corresponding beamforming gain decrease. That is, since the RSRP does not vary, the UE cannot detect that the TA may be no longer valid.

On the other hand, with regard to UE 11 (inter-beam movement example), the UE 11 moves between different SSBs (i.e. different beams) while maintaining the same distance to the gNB, which results on the UE 11 observing a variation on the measured RSRP while still keeping a valid TA.

That is, FIG. 1 illustrates examples where beamforming can disrupt the measured RSRP, but where it is not possible to ascertain whether the UE still has a valid TA. In other words, a cell-level RSRP based TA validity detection may not be suitable in a NR system due to the multi-beam scenarios.

It is therefore required to introduce a more robust detection of the TA misalignment in NR for CG-based SDT.

One possible approach to solve this problem is, for example, PUR based EDT (Early Data Transmission). EDT allows one uplink transmission from RRC_IDLE using a preconfigured uplink resource (PUR) without performing a random access procedure. The TA validation criteria in PUR depend, for example, on RSRP variation which includes time alignment timer and RSRP change threshold.

Specifically, the following TA validation approaches based on neighbor cell measurements are conceivable for PUR. One approach may be to determine TA validity on the basis of an estimation of the UE position changing using by neighboring cell measurements.

A further approach may be to use neighbor cell RSRP change and serving cell's RSRP change. In case the serving cell's RSRP changes by more than a threshold, the TA is deemed to be invalid. Similarly, in case any neighbor cell RSRP changes by more than a threshold, the TA is also deemed to be invalid.

Yet another approach is based to determine TA validity based on TDOA of DL reference signals between serving and neighbor cell of two or more eNBs.

For cell reselection in multi-beam operations, in NR scenarios, it is also possible that the UE is configured with thresholds to determine a cell-level RSRP quantity based on the average of beam-level RSRP quantities. That is, the cell level measurement quantity is the linear average of the measurement quantity values of nrofSS-BlocksToAverage (e.g. N) beams above the absThreshSS-BlocksConsolidation threshold. In case there is no beam above the consolidation threshold, the UE considers cell measurement quantity to be equal to the highest beam measurement quantity (i.e. cell-level RSRP=strongest beam RSRP).

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is obvious for a person skilled in the art that the embodiments may also be applied to other kinds of communication networks, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit, which controls a respective coverage area or cell(s) and with which one or more communication stations such as communication elements or functions, like user devices or terminal devices, a UE, an IoT element or device, a router device, or any another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The general functions and interconnections of the described elements and functions, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet, as well as with individual devices or groups of devices being not considered as a part of a network, such as monitoring devices like cameras, sensors, arrays of sensors, and the like. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, and IoT device, a router or the like, a terminal device, control elements or functions, such as access network elements, like a base station (BS), a gNB, a radio network controller, a core network control element or function, such as a gateway element, or other network elements or functions, such as management elements or functions, as described herein, and any other elements, functions or applications may be implemented by software, e.g. by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

According to examples of embodiments, there is proposed a mechanism that allows that a communication element of function (in the following, as an example for a communication element, reference is made to a UE) validates whether its TA setting is still valid before performing a CG-SDT transmission. Specifically, according to examples of embodiments, there is proposed a mechanism which can be applied, for example, in a situation where the last serving beam has not changed, i.e. the UE's DL serving beam (e.g. SSB) matches the (default) beam for which it was assigned CG-SDT resources, in other words, in a situation according to an intra beam movement as discussed in connection with UE 10 in FIG. 1, i.e. an intra-beam TA validation. By means of the measures provided in the mechanism according to examples of embodiments, it is possible to detect if any eventual intra-beam UE movement was of such magnitude that a TA setting is to be deemed to be no longer valid.

It is to be noted that according to examples of embodiments, reference is made to metrics indicating at least one of a signal level and a signal quality of at least one beam. Examples for such metrics are reference signals received power (RSRP) and reference signal received quality (RSRQ) of one or more beams associated with the communication network. RSRP and RSRQ are key measures of signal level and quality for wireless communication networks. In cellular networks, RSRP and RSRQ are used, for example, when a mobile device such as a UE moves from cell to cell and performs cell selection/reselection and handover and has to measure the signal strength/quality of the neighbor cells. RSRP indicates e.g. the power of reference signals spread over the full bandwidth and narrowband. RSRQ indicates the quality of the received reference signal. The RSRQ measurement provides additional information when RSRP is not sufficient to make a reliable handover or cell reselection decision, for example. It is to be noted that the RSRP and RSRQ values can be instantaneous or filtered at different communication layers; for example, periodically measured RSRP values can be averaged over a time window to obtain a L1-RSRP value.

Specifically, examples of embodiments are related to a TA validation procedure comprising evaluation of beam based TA validity conditions and rules based on metrics, such as beam-level RSRP/RSRQ metrics or cell-level RSRP/RSRQ metrics, and accounting for a UE-specific set of relevant beams.

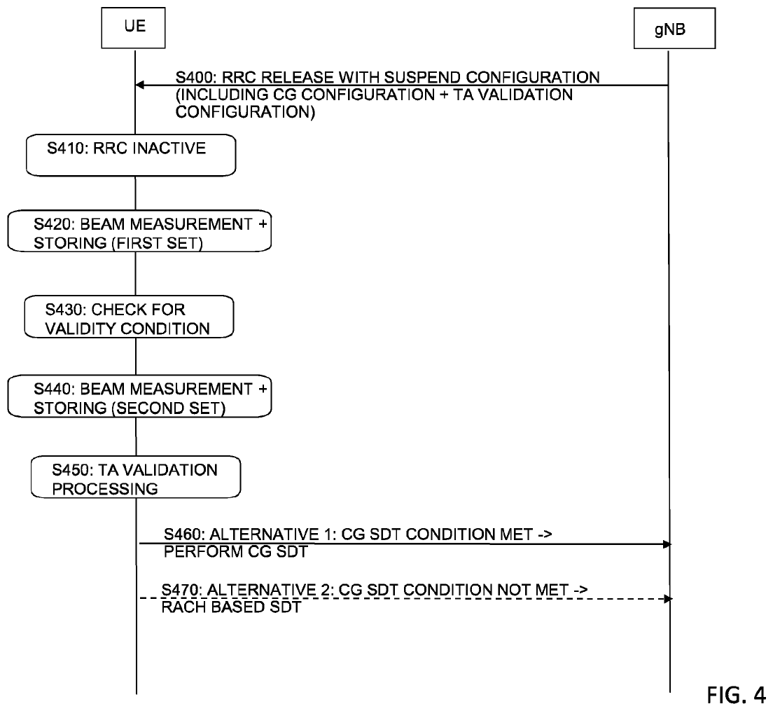

FIG. 4 shows a signaling diagram explaining an example of embodiments of a SDT processing according to some examples of embodiments, wherein an intra-beam TA validation procedure is involved. It is to be noted that in the following description, for the sake of convenience, beam-level RSRP is assumed as metric for TA validation; however, as indicated above, a corresponding procedure can be applied also when considering other metrics, such as beam-level RSRQ (additionally or alternatively), or cell-level RSRP/RSRQ, wherein cell-level RSRP/RSRQ can be derived, for example, by averaging measurements of a plurality of beam-level RSRP/RSRQ.

In S400, the gNB (e.g. gNB 20 as shown in FIG. 1) instructs the transition of the UE from RRC_CONNECTED to RRC_INACTIVE with the transmission of an RRC release message that includes suspend configuration information (e.g. I-RNTI, RAN-PagingCycle, RAN-NotificationAreaInfo and timer information). According to examples of embodiments, the configuration information includes also CG configuration information for CG SDT, as well as TA validation information, such as thresholds, indication of metrics to be used, rules to be considered, as described below, and the like.

In S410, at a time instant t0, the UE is in inactive state and has a valid TA setting. For example, the UE has either been assigned the CG-SDT resources or has completed a successful CG-SDT transmission (i.e. upon receiving DL acknowledgement), so that a valid TA is present.

In S420, the UE conducts a processing for obtaining metrics indicating at least one of a signal level and a signal quality of at least one beam. For example, the UE conducts a corresponding measurement or estimation of corresponding metrics. For example, the UE measures and stores the RSRP of the N^{th} strongest beams (e.g. of beams A to E), wherein the beams are measured along with their associated beam ID. In the following, the information is denoted NSBₜ₀ (i.e. as a first set).

For example, the UE measures the (SS/CSI-) RSRP associated with the configured serving beam(s) as well as the (SS/CSI-) RSRP of the n^{th} strongest non-serving beams. The n^{th} strongest non-serving beams can be indicated to the UE in different ways, e.g. by the configuration information in S400, or as preset setting. For example, the n^{th} strongest non-serving beams can be a predetermined number (n) of beams being the beams having the strongest signal strengths, amongst all beams which can be received. Alternatively, the n^{th} strongest non-serving beams concern those beams whose signal strength is above a certain threshold which is provided, for example, be the network (e.g. the gNB). Furthermore, the network can also directly indicate which beams are to be considered for obtaining the metrics, e.g. by providing an ID of the corresponding beam.

Furthermore, it is to be noted that obtaining the metrics includes a measurement conducted by the UE or an estimation of a corresponding metric, e.g. on the basis of measurement results of other beams, or the like.

As indicated above, as a part of the CG-SDT configuration received in S400, which includes the indication of time and frequency resources as well as the SSB beam(s) for which these resources are valid as well the associated beam-level RSRP threshold for SDT selection, the UE is configured, according to some examples of embodiments, to measure the n^{th} strongest beams, wherein the configuration may include a minimum RSRP threshold for a non-serving beam to be considered in these measurements. It is to be noted that a non-serving beam includes any beam other than the current/default beam.

According to one example, the current (wide) beam is the one with the strongest (SS/CSI-) RSRP at time t0. On the other hand, according to another aspect, the default (wide) beam can be assigned as follows. In case the UE is in RRC CONNECTED state at the time it receives the CG-SDT configuration (in S400), the UE is likely to operate on a narrow serving beam that was assigned by the network as part of the beam management procedure based on UE reporting of periodic L1-RSRP derived based on CSI-RS resources. The (wide) beam corresponding to the current serving narrow beam can now be assigned as the default SSB beam for SDT operations.

According to an alternative embodiment, the network, i.e. the gNB 20, indicates specific non-serving beams, for example in the configuration information. In case one or more of these specific non-serving beams is detected by the UE to be above a pre-configured RSRP threshold, this indicates that the UE has no longer a valid TA setting.

Furthermore, according to one aspect, the UE is assigned, implicitly or explicitly, a UE-specific set of beams based on the UE's last serving beam, wherein the UE-specific set of beams contains the last serving beam and one or more neighbor beams. This UE-specific set of beams is then used as the basis for the measurement.

In S430, at a time instant t1, prior to attempting a CG-SDT transmission, the UE checks for validity conditions. Specifically, the UE checks whether the current serving beam meets CG SDT validity conditions, i.e. whether it is under a valid serving beam for the CG-SDT. That is, it is determined whether the serving beam matches to one of the configured beam(s) for CG-SDT and whether the (SS/CSI-) RSRP associated to the current serving beam is above the configured threshold for (CG-)SDT selection.

It is to be noted that the process of S430 is optional and may be also omitted. That is, for example, the UE may assume that a corresponding condition is always valid or can be ignored.

In case S430 is conducted and it is determined that the validity conditions are not met, i.e. that the UE is not under a valid serving beam for the CG-SDT, then the CG-SDT transmission cannot proceed. In such a case, a fall-back procedure takes place, which is e.g. in accordance with the processing as described in S470. That is, SDT is conducted without using the CG resources.

On the other hand, In case it is determined that the validity conditions are met, i.e. the UE is under a valid serving beam for the CG-SDT, and the measured (SS/CSI-) RSRP is above the configured threshold, the UE proceeds to the next step S440.

In S440, before a small data transmission is conducted, the UE conducts a processing for obtaining metrics indicating at least one of a signal level and a signal quality of at least one beam associated with the communication network. For example, similarly to the processing in S420, the UE conducts a corresponding measurement or estimation of corresponding metrics. That is, the UE measures and stores the RSRP of N^{th} strongest beams (e.g. of beams A to E) at the time t1, wherein the beams are measured along with their associated beam ID. In the following, the information is denoted NSBn. That is, the UE records, besides measuring the (SS/CSI-) RSRP of the n^{th} strongest non-serving beams at time instant t1, also the associated beam ID. The resulting (SS/CSI-) RSRP and beam ID pair is stored in the set of n^{th} strongest beams at time instant t1, denoted as NSBₜ₁ (i.e. as a second set). Again, similarly to S420, the n^{th} strongest non-serving beams can be indicated to the UE in different ways, e.g. by the configuration information in S400, or as preset setting. For example, the n^{th} strongest non-serving beams can be a predetermined number (n) of beams being the beams having the strongest signal strengths, amongst all beams which can be received. Alternatively, the n^{th} strongest non-serving beams concern those beams whose signal strength is above a certain threshold which is provided, for example, be the network (e.g. the gNB). Furthermore, the network can also directly indicate which beams are to be considered for obtaining the metrics, e.g. by providing an ID of the corresponding beam. Furthermore, it is to be noted that obtaining the metrics includes a measurement conducted by the UE or an estimation of a corresponding metric, e.g. on the basis of measurement results of other beams, or the like.

In S450, the UE conducts a TA validation processing based on collected measurement results, i.e. the first and second sets indicated above. That is, the UE applies one or more of the following beam-based conditions and rules so as to validate if the UE's TA setting is still valid at t1, based on the acquired beam-level RSRP measurements.

According to examples of embodiments, one or more of the following rules or conditions are to be met so as to determine that the TA setting is valid, i.e. one or more of the following beam-based conditions/rules are to be fulfilled

According to examples of embodiments, as a rule or condition for TA validation, it is checked whether UE is within the last serving beam or default beam, i.e. whether the current beam ID matches the ID of the beam assigned as default/last serving. If this is the case, the condition for a valid TA setting can be seen as fulfilled.

According to further examples of embodiments, as a rule or condition for TA validation, it is checked whether at least m-out-of-the-n strongest beams in NSBₜ₁ (the second set) are present in NSBₜ₀ (the first set). It is to be noted that according to some examples of embodiments, m can be indicated as a part of the CG-SDT configuration information in S400, or can be a value being preset in the UE. If this is the case, the condition for a valid TA setting can be seen as fulfilled.

According to further examples of embodiments, as an additional or alternative rule or condition for TA validation, it is checked whether the observed RSRP variations of the individual beams, comprising the serving beam and the m non-serving beams (m is e.g. the same parameter as indicated above) within NSBₜ₁ are all below a configured threshold. It is to be noted that according to some examples of embodiments, it is also possible to consider only a subset, i.e. at least k1 of the observed RSRP variations of the individual beams, for the above described purpose, wherein k1 can be part of the CG-SDT configuration in S400. For example, for a beam i, the following condition (1) can be applied:

|RSRP_{i,t0}−RSRP_{i,t1}|<RSRPThreshold₁ᵢ; (1)

According to further examples of embodiments, as an additional or alternative rule or condition for TA validation, it is checked whether an observed relative RSRP variation of one or more pairs0 of beams, comprising the serving beam and the m non-serving beams within the NSBₜ₁ are all (or at least k2 of them) below a configured threshold.

Alternatively or additionally, each individual condition can be performed pair-wise between the serving beam s and non-serving beam i as,

∥RSRP_{s,t0}−RSRP_{i,t0}|−|RSRP_{s,t1}−RSRP_{i,t1}∥<RSRPThreshold_{2i,s} (2)

Alternatively, each condition can be performed between a pair of non-serving beam j and i as,

∥RSRP_{j,t0}−RSRP_{i,t0}|−|RSRP_{j,t1}−RSRP_{i,t1}∥<RSRPThreshold_{3i,j} (3)

Alternatively, each condition can be performed by applying it directly between the serving beam and the k2 strongest non-serving beams within NSBₜ₁ as,

∥RSRP_{s,t0}−Σᵢ^{k2}RSRP_{i,t0}|−|RSRP_{s,t1}−Σiᵣₖ₂RSRP_{i,t1}∥<RSRPThreshold₄ (4)

Furthermore, according to some examples of embodiments, when it is assumed that the network, i.e. the gNB 20, indicates specific non-serving beams in S400, as an additional or alternative rule or condition for TA validation, it is checked whether the UE does not detect that the indicated non-serving beams (for TA setting invalidation) are above a pre-configured RSRP threshold.

Depending on the result of the TA validation processing in S450, the UE decides whether the CG SDT conditions being set are met or not.

In case the CG SDT conditions are met, i.e. the TA setting is determined to be valid, and any additional CG SDT validity condition that may apply as well is determined to be met, the UE proceeds to S460 (alternative 1) where the CG SDT according to the CG conditions received in S400 is performed.

On the other hand, in case the CG SDT conditions are met, i.e. the TA setting is determined to be not valid, or any additional CG SDT validity condition that may apply as well is determined to be not met, the UE proceeds to S470 (alternative 2) where

the UE fallbacks to RACH based SDT or a legacy resume.

According to an alternative implementation, in the processing in S450, the evaluation processing based on RSRP variations in individual beams or in one or more beam pairs can be executed also on the basis of a cell-level RSRP rather than the strongest beam RSRP. This is because cell-level RSRP which the UE in RRC

INACTIVE state computes, for example, for cell reselection purposes is strongly affected by the strongest beam. Hence, a cell-level RSRP can be estimated on the basis of e.g. one or more of the strongest beams. Thus, a condition based on cell-level RSRP is basically equivalent to a condition based on the strongest beam RSRP.

In another alternative implementation, the UE may use the beam-based L1-RSRPs at t0 and stores the serving beam(s) L1-RSRP(s) and the n-strongest non-serving beams L1-RSRPs for TA evaluation. In addition, the (L1-)RSRP measurements for random access and/or CG-SDT resource selection can be for TA evaluation, as the (L1-)RSRP value at t1.

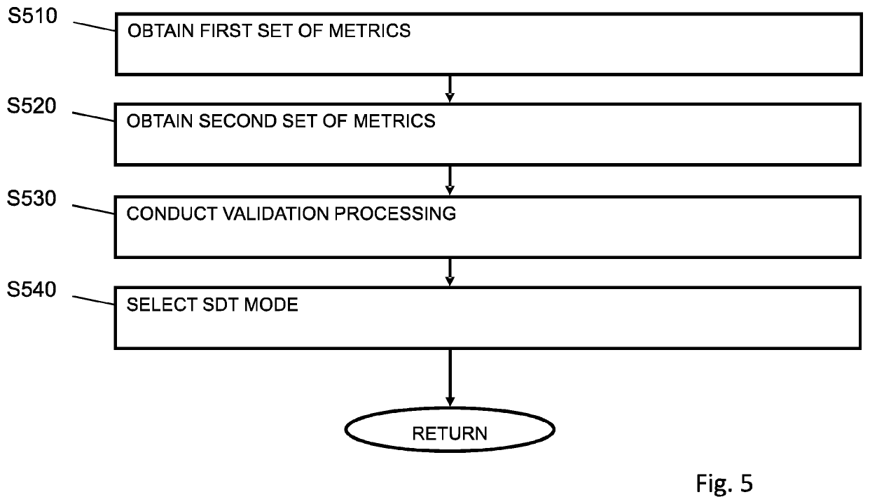

FIG. 5 shows a flow chart of a processing executed by a communication element or function, such as the UE 10 of FIG. 1, as described above. That is, FIG. 5 shows a flowchart related to a processing conducted by a network element or function like a UE configured to act as a communication element or function in a communication network, as also described in connection with FIG. 4. As indicated above, the communication network may be based on a 3GPP standard. However, also other communication standards can be used, according to other examples of embodiments.

In S510, a first set of metrics is obtained which indicates at least one of a signal level and a signal quality of at least one beam associated with the communication network.

According to examples of embodiments, obtaining is related to one of signal measurement or beam measurement at the UE side, an estimation of values corresponding to the metrics, e.g. based on measurements of other beams, a provision of corresponding information from another source, e.g. from another UE being In the vicinity of the UE conducting the processing, or the like.

Furthermore, according to examples of embodiments, as the first set of metrics, metrics indicating the at least one of the signal level and the signal quality of a serving beam (or default beam) and of non-serving beams is/are obtained. For example, the non-serving beams comprises one of a predetermined number of non-serving beams having the strongest signal strength compared to other non-serving beams (i.e. N strongest beams), or a set of non-serving beams having a signal strength being above a predetermined threshold (which is provided, for example, by the network, e.g. a gNB to which the beams are associated), or a set of non-serving beams being identified by the communication network (that is, the gNB indicates which beams are to be measured, or the like, e.g. by means of an ID indication).

Moreover, according to examples of embodiments, the metrics indicating the at least one of the signal level and the signal quality of the at least one beam associated with the communication network comprises at least one of a RSRP value and a RSRQ value obtained for the at least one beam associated with the communication network.

Furthermore, the metrics indicating the at least one of the signal level and the signal quality of the at least one beam associated with the communication network are at least one of beam related values (e.g. beam-level RSRP/RSRQ) and cell related values (e.g. cell-level RSRP/RSRQ). Furthermore, the values of the metrics are related to at least one of a serving beam, a default beam and non-serving beams having the strongest signal strength, for example.

According to examples of embodiments, the first set of metrics indicating the at least one of the signal level and the signal quality of the at least one beam associated with the communication network is obtained when the communication element or function is in an inactive RRC state having a valid TA setting for communicating with a serving access network control element or function (e.g. a gNB to which the beams are associated).

In S520, before a small data transmission is conducted, a second set of metrics is obtained, which indicates at least one of a signal level and signal quality of at least one beam associated with the communication network,

Similarly to S510, according to examples of embodiments, obtaining is related to one of signal measurement or beam measurement at the UE side, an estimation of values corresponding to the metrics, e.g. based on measurements of other beams, a provision of corresponding information from another source, e.g. from another UE being In the vicinity of the UE conducting the processing, or the like.

Furthermore, according to examples of embodiments, as the second set of metrics, metrics indicating the at least one of the signal level and the signal quality of a serving beam (or default beam) and of non-serving beams is/are obtained. For example, the non-serving beams comprises one of a predetermined number of non-serving beams having the strongest signal strength compared to other non-serving beams (i.e. N strongest beams), or a set of non-serving beams having a signal strength being above a predetermined threshold (which is provided, for example, by the network, e.g. a gNB to which the beams are associated), or a set of non-serving beams being identified by the communication network (that is, the gNB indicates which beams are to be measured, or the like, e.g. by means of an ID indication).

Moreover, according to examples of embodiments, the metrics indicating the at least one of the signal level and the signal quality of the at least one beam associated with the communication network comprises at least one of a RSRP value and a RSRQ value obtained for the at least one beam associated with the communication network.

Furthermore, the metrics indicating the at least one of the signal level and the signal quality of the at least one beam associated with the communication network are at least one of beam related values (e.g. beam-level RSRP/RSRQ) and cell related values (e.g. cell-level RSRP/RSRQ). Furthermore, the values of the metrics are related to at least one of a serving beam, a default beam and non-serving beams having the strongest signal strength, for example.

According to examples of embodiments, both of the first set and the second set of metrics indicating the at least one of the signal level and the signal quality of the at least one beam associated with the communication network are stored in a suitable memory, wherein an identification of the corresponding beam being processed/measured is stored in connection with the corresponding metric value.

According to examples of embodiments, before the second set of metrics is obtained, i.e. before the small data transmission is conducted, it is possible to conduct a check as to whether a signal level or a signal quality of a serving beam (i.e. an RSRP/RSRQ value, for example) fulfills a validity condition for a small data transmission in an inactive connection state. In case the check is negative, a random access procedure for a small data transmission may be conducted. Otherwise, in case the check is positive, S520 is conducted.

In S530, a validation processing is conducted for determining whether a TA setting is valid, i.e. whether the SDT can be conducted properly. The determination is based, for example, on the obtained first set of metrics and the obtained second set of metrics. Moreover, a preset rule related to at least one beam related to the communication network is used.

According to examples of embodiments, the preset rule used for conducting the validation processing comprises at least one of the following:
a comparison of identifications of serving beams in the first set of metrics and the second set of metrics (that is, it is determined whether IDs of the serving beams matches, i.e. whether the serving beam is still the same),
a comparison of identifications of sets of beams in the first set of metrics and the second set of metrics (that is, it is determined whether e.g. m out of n strongest beams in the second set are present in the first set),
a comparison of variations of obtained metrics of individual beams with a predetermined first threshold (that is, it is determined whether observed RSRP/RSRQ variations in individual beams (serving/non-serving) in the second set of metrics are below a threshold),
a comparison of variations of obtained metrics of paired beams with a predetermined second threshold (that is, it is determined whether observed RSRP/RSRQ variations of one or more pairs of beams (serving/non-serving) are below a threshold),
a comparison of obtained metrics of non-serving beams with a predetermined third threshold (that is, it is determined that the RSRP/RSRQ values for non-serving beams are not above a threshold).

It is to be noted that the above first, second and third thresholds are usually different to each other and can be configured according to the requirements being faced in the communication network.

In S540, a mode for the small data transmission is selected on the basis of a result of the validation processing in S530.

That is, a configured grant small data transmission (CG SDT) is selected as the small data transmission mode when the result of the validation processing in S530 indicates that a valid TA setting is present. On the other hand, it is selected to use as a small data transmission mode a processing in which a random access procedure for the small data transmission is conducted, in case the result of the validation processing in S530 indicates that no valid TA setting is present.

It is to be noted that according to examples of embodiments, before the processing described in connection with S510 to S540 is conducted, the communication element of function, e.g. the UE, receives, from an access network control element or function, configuration information and processes the same for configured the above described processing.

The configuration information concerns, for example, settings for obtaining the metrics indicating the at least one of the signal level and the signal quality of the at least one beam associated with the communication network, including an indication allowing to determine beams to be measured. That is, for example, the network indicates how the metrics are to be obtained (by measurement, by estimation, combination thereof), which beams are to be considered (predetermined number, strongest beams, beams stronger than threshold, as described above, for example), where results of the obtaining are to be stored, and the like.

Furthermore, the configuration information concerns settings for conducting the validation processing. For example, it is indicated which metrics are to be used for the validation processing, which rule(s) is(are) to be used, and the like.

Moreover, the configuration information concerns settings for the small data transmission. This comprises, for example, an indication of resources to be used for the small data transmission (e.g. which beam is to be used for the transmission, which type of back-fall SDT mode is to be used (RACH based or the like), according to the selected SDT mode in S540.

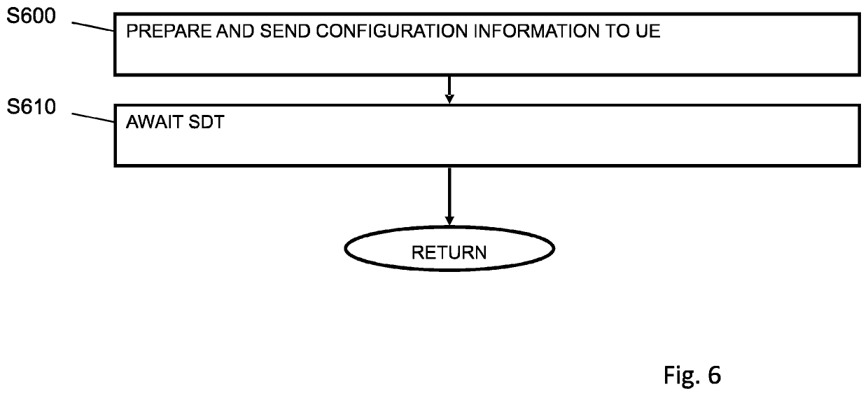

FIG. 6 shows a flow chart of a processing executed by a communication network control element or function, such as the gNB 20 of FIG. 1, as described above. That is, FIG. 6 shows a flowchart related to a processing conducted by a network element or function like a UE configured to act as a communication network control element or function controlling a communication of a communication element or function (i.e. of an UE, for example) in a communication network, as also described in connection with FIG. 4. As indicated above, the communication network may be based on a 3GPP standard. However, also other communication standards can be used, according to other examples of embodiments.

In S600, configuration information is prepared and sent to the communication element or function (e.g. the UE) being served. S600 corresponds the S400 in FIG. 4, for example.

Specifically, the configuration information concerns, for example, settings for obtaining metrics indicating at least one of a signal level and a signal quality of at least one beam associated with the communication network, including an indication allowing to determine beams to be measured. That is, for example, the network indicates how the metrics are to be obtained (by measurement, by estimation, combination thereof), which beams are to be considered (predetermined number, strongest beams, beams stronger than threshold, for example), where results of the obtaining are to be stored, and the like.

Specifically, according to examples of embodiments, the configuration information includes instructions to obtain a first set of metrics indicating the at least one of the signal level and the signal quality of a serving beam and of non-serving beams.

According to examples of embodiments, the instructions indicate that the first set of metrics indicating the at least one of the signal level and the signal quality of the at least one beam associated with the communication network is to be obtained when the communication element or function (i.e. the UE) is in an inactive RRC state having a valid TA setting for communicating with a serving access network control element or function (e.g. a gNB to which the beams are associated). The entering of the inactive RRC state can be instructed, for example, in connection with the transmission of the configuration information (see also S400 in FIG. 4).

According to examples of embodiments, obtaining is related to one of signal measurement or beam measurement at the UE side, an estimation of values corresponding to the metrics, e.g. based on measurements of other beams, a provision of corresponding information from another source, e.g. from another UE being In the vicinity of the UE conducting the processing, or the like.

Furthermore, according to examples of embodiments, as the first set of metrics, metrics indicating the at least one of the signal level and the signal quality of a serving beam (or default beam) and of non-serving beams is/are obtained. For example, the non-serving beams comprises one of a predetermined number of non-serving beams having the strongest signal strength compared to other non-serving beams (i.e. N strongest beams), or a set of non-serving beams having a signal strength being above a predetermined threshold (which is provided, for example, by the network, e.g. a gNB to which the beams are associated), or a set of non-serving beams being identified by the communication network (that is, the gNB indicates which beams are to be measured, or the like, e.g. by means of an ID indication).

Moreover, according to examples of embodiments, the metrics indicating the at least one of the signal level and the signal quality of the at least one beam associated with the communication network comprises at least one of a RSRP value and a RSRQ value obtained for the at least one beam associated with the communication network.

Furthermore, the metrics indicating the at least one of the signal level and the signal quality of the at least one beam associated with the communication network are at least one of beam related values (e.g. beam-level RSRP/RSRQ) and cell related values (e.g. cell-level RSRP/RSRQ). Furthermore, the values of the metrics are related to at least one of a serving beam, a default beam and non-serving beams having the strongest signal strength, for example.

Furthermore, the configuration information includes instructions to obtain, before a small data transmission is to be conducted, a second set of metrics indicating the at least one of the signal level and the signal quality of the serving beam or a default beam and of non-serving beams.

Similarly to the first set of metrics, according to examples of embodiments, for the second set of metrics, obtaining is related to one of signal measurement or beam measurement at the UE side, an estimation of values corresponding to the metrics, e.g. based on measurements of other beams, a provision of corresponding information from another source, e.g. from another UE being In the vicinity of the UE conducting the processing, or the like.

Furthermore, according to examples of embodiments, as the second set of metrics, metrics indicating the at least one of the signal level and the signal quality of a serving beam (or default beam) and of non-serving beams is/are obtained. For example, the non-serving beams comprises one of a predetermined number of non-serving beams having the strongest signal strength compared to other non-serving beams (i.e. N strongest beams), or a set of non-serving beams having a signal strength being above a predetermined threshold (which is provided, for example, by the network, e.g. a gNB to which the beams are associated), or a set of non-serving beams being identified by the communication network (that is, the gNB indicates which beams are to be measured, or the like, e.g. by means of an ID indication).

Moreover, according to examples of embodiments, the metrics indicating the at least one of the signal level and the signal quality of the at least one beam associated with the communication network comprises at least one of a RSRP value and a RSRQ value obtained for the at least one beam associated with the communication network.

Furthermore, the metrics indicating the at least one of the signal level and the signal quality of the at least one beam associated with the communication network are at least one of beam related values (e.g. beam-level RSRP/RSRQ) and cell related values (e.g. cell-level RSRP/RSRQ). Furthermore, the values of the metrics are related to at least one of a serving beam, a default beam and non-serving beams having the strongest signal strength, for example.

According to examples of embodiments, instructions can be provided in the configuration information that both of the first set and the second set of metrics indicating the at least one of the signal level and the signal quality of the at least one beam associated with the communication network are stored in a suitable memory, wherein an identification of the corresponding beam being processed/measured is to be stored in connection with the corresponding metric value.

Furthermore, the configuration information concerns settings for conducting a validation processing. For example, it is indicated which metrics are to be used for the validation processing, which rule(s) is(are) to be used, and the like.

Specifically, according to examples of embodiments, the validation processing is to be conducted for determining whether a TA setting is valid, i.e. whether the SDT can be conducted properly. The determination is to be based, for example, on the first set of metrics and the second set of metrics. Moreover, a preset rule related to at least one beam related to the communication network can be provided or indicated in the configuration information.

According to examples of embodiments, the preset rule used for the validation processing comprises at least one of the following:
a comparison of identifications of serving beams in the first set of metrics and the second set of metrics (that is, it is to be determined whether IDs of the serving beams matches, i.e. whether the serving beam is still the same),
a comparison of identifications of sets of beams in the first set of metrics and the second set of metrics (that is, it is to be determined whether e.g. m out of n strongest beams in the second set are present in the first set),
a comparison of variations of obtained metrics of individual beams with a predetermined first threshold (that is, it is to be determined whether observed RSRP/RSRQ variations in individual beams (serving/non-serving) in the second set of metrics are below a threshold),
a comparison of variations of obtained metrics of paired beams with a predetermined second threshold (that is, it is to be determined whether observed RSRP/RSRQ variations of one or more pairs of beams (serving/non-serving) are below a threshold),
a comparison of obtained metrics of non-serving beams with a predetermined third threshold (that is, it is to be determined that the RSRP/RSRQ values for non-serving beams are not above a threshold).

It is to be noted that the above first, second and third thresholds are usually different to each other and can be configured according to the requirements being faced in the communication network.

According to further examples of embodiments, the configuration information further includes instructions to select, as the small data transmission mode, a configured grant small data transmission (CG SDT) when the result of the validation processing indicates that a valid TA setting is present, and to select, as the small data transmission mode, to conduct a random access procedure for the small data transmission when the result of the validation processing indicates that no valid TA setting is present. This also comprises, for example, an indication of resources to be used for the small data transmission (e.g. which beam is to be used for the transmission, which type of back-fall SDT mode is to be used (RACH based or the like).

In S610, the gNB awaits a SDT from the UE, e.g. according to one of S460 and S470 in FIG. 4.

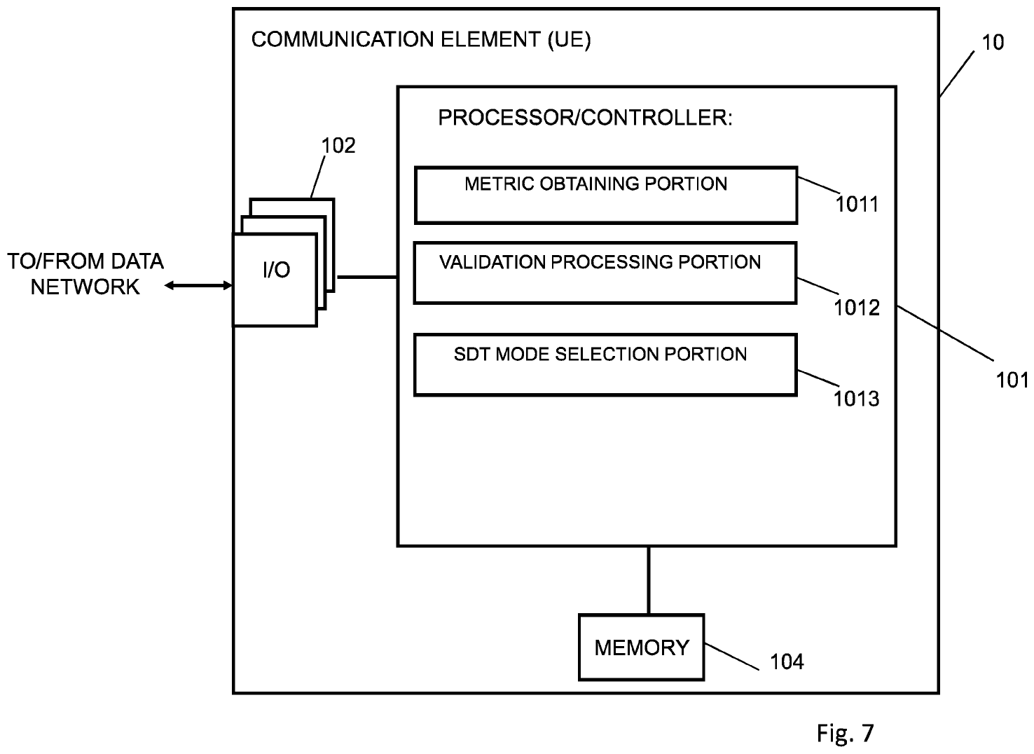

FIG. 7 shows a diagram of a network element or function usable as a communication element or function, which may be, for example, the UE 10 as shown in the communication system of FIG. 1, and which is configured to conduct a processing according to examples of embodiments of the disclosure. It is to be noted that the network element or function being used may include further elements or functions besides those described herein below. Furthermore, even though reference is made to a communication element or function, the element or function may be also another device or function having a similar task, such as a chipset, a chip, a module, an application etc., which can also be part of a network element or attached as a separate element to a communication element, or the like. It should be understood that each block and any combination thereof may be implemented by various means or their combinations, such as hardware, software, firmware, one or more processors and/or circuitry.

The communication element or function 10 shown in FIG. 7 may include a processing circuitry, a processing function, a control unit or a processor 101, such as a CPU or the like, which is suitable for executing instructions given by programs or the like related to the control procedure. The processor 101 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 102 denotes input/output (I/O) units or functions (interfaces) connected to the processor or processing function 101. The I/O units 102 may be used for communicating with a communication network, in particular an access network element or function such as gNB 20 shown in FIG. 1. The I/O units 102 may be combined units including communication equipment towards several entities, or may include a distributed structure with a plurality of different interfaces for different entities. Reference sign 104 denotes a memory usable, for example, for storing data and programs to be executed by the processor or processing function 101 and/or as a working storage of the processor or processing function 101. It is to be noted that the memory 104 may be implemented by using one or more memory portions of the same or different type of memory.

The processor or processing function 101 is configured to execute processing related to the above described SDT processing. In particular, the processor or processing circuitry or function 101 includes at least one or more of the following sub-portions. Sub-portion 1011 is a processing portion which is usable as a portion for obtaining metrics. The portion 1011 may be configured to perform processing according to S510 and S520 of FIG. 5. In addition, the processor or processing circuitry or function 101 may include a sub-portion 1012 usable as a portion for conducting a validation processing. The portion 1012 may be configured to perform a processing according to S530 of FIG. 5. Moreover, the processor or processing circuitry or function 101 may include a sub-portion 1013 usable as a portion for selecting a SDT mode. The portion 1013 may be configured to perform a processing according to S540 of FIG. 5.

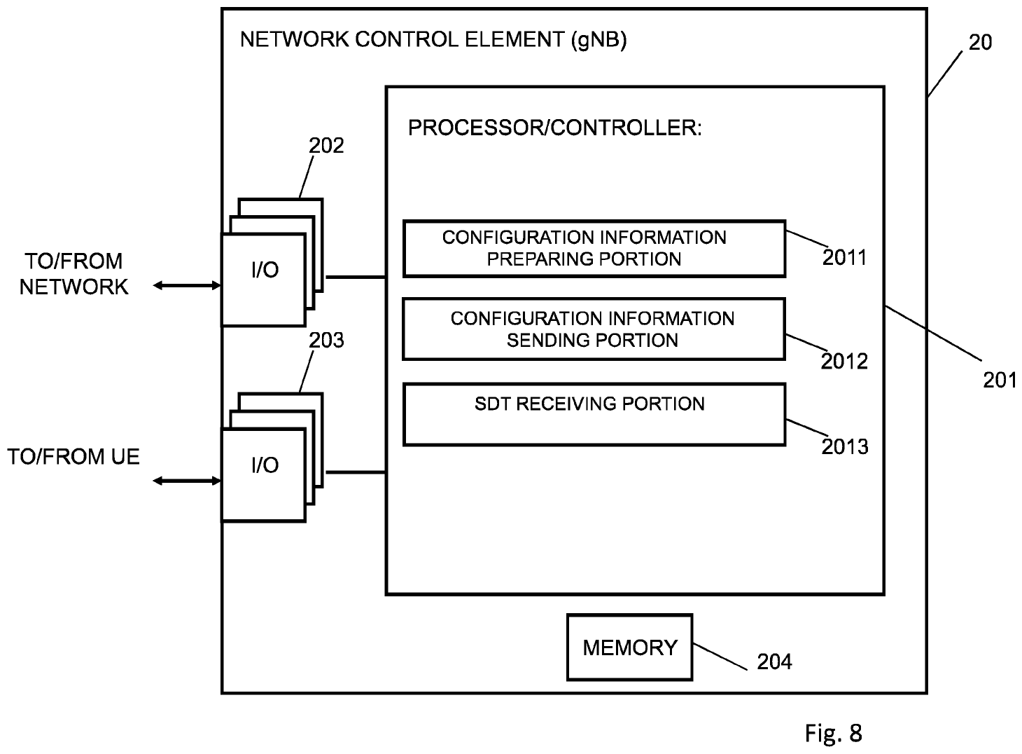

FIG. 8 shows a diagram of a network element or function usable as a communication network control element or function, which may be, for example, the gNB 20 as shown in the communication system of FIG. 1, and which is configured to conduct a processing according to examples of embodiments of the disclosure. It is to be noted that the network element or function being used may include further elements or functions besides those described herein below. Furthermore, even though reference is made to a communication network control element or function, the element or function may be also another device or function having a similar task, such as a chipset, a chip, a module, an application etc., which can also be part of a network element or attached as a separate element to a communication network control element, or the like. It should be understood that each block and any combination thereof may be implemented by various means or their combinations, such as hardware, software, firmware, one or more processors and/or circuitry.

The communication network control element or function 20 shown in FIG. 8 may include a processing circuitry, a processing function, a control unit or a processor 201, such as a CPU or the like, which is suitable for executing instructions given by programs or the like related to the control procedure. The processor 201 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 202 and 203 denote input/output (I/O) units or functions (interfaces) connected to the processor or processing function 201. The I/O units 202 may be used for communicating with a network, such as a core network of a communication network. The I/O units 203 may be used for communicating with a UE, for example, the UE 10 communicating in the communication network. The I/O units 202 and 203 may be combined units including communication equipment towards several entities, or may include a distributed structure with a plurality of different interfaces for different entities. Reference sign 204 denotes a memory usable, for example, for storing data and programs to be executed by the processor or processing function 201 and/or as a working storage of the processor or processing function 201. It is to be noted that the memory 204 may be implemented by using one or more memory portions of the same or different type of memory.

The processor or processing function 201 is configured to execute processing related to the above described SDT processing. In particular, the processor or processing circuitry or function 201 includes at least one or more of the following sub-portions. Sub-portion 2011 is a processing portion which is usable as a portion for preparing configuration information. The portion 2011 may be configured to perform processing according to S600 of FIG. 6. Furthermore, the processor or processing circuitry or function 201 may include a sub-portion 2012 usable as a portion for sending the configuration information. The portion 2012 may be configured to perform a processing according to S600 of FIG. 6. In addition, the processor or processing circuitry or function 201 may include a sub-portion 2013 usable as a portion for receiving an SDT. The portion 2013 may be configured to perform a processing related to S610 of FIG. 6.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

According to examples of embodiments, the UE may have stored information or instructions required for the processing to be conducted in the above described small data transmission mechanism, in particular with regard to the measures executed in the TA validation processing. Alternatively or additionally, a part or all of the necessary information or instructions can be provided by the network, e.g. the gNB, by means of the configuration information transmitted to the UE.

According to a further example of embodiments, there is provided, for example, an apparatus for use by a communication element or function configured to act as a communication element or function in a communication network, the apparatus comprising means configured to obtain a first set of metrics indicating at least one of a signal level and a signal quality of at least one beam associated with the communication network, means configured to obtain, before a small data transmission is conducted, a second set of metrics indicating at least one of a signal level and signal quality of at least one beam associated with the communication network, means configured to conduct a validation processing for determining whether a timing advance setting is valid, wherein the determination is based on the measured first set of metrics and the measured second set of metrics and a preset rule related to at least one beam related to the communication network, and means configured to select a small data transmission mode on the basis of a result of the validation processing.

Furthermore, according to some other examples of embodiments, the above defined apparatus may further comprise means for conducting at least one of the processing defined in the above described methods, for example a method according to that described in connection with FIG. 5.

According to a further example of embodiments, there is provided, for example, an apparatus for use by a communication network control element or function configured to act as an access network control element or function controlling a communication of a communication element or function in a communication network, the apparatus comprising means configured to prepare and send, to the communication element or function being served, configuration information of settings for measuring metrics indicating at least one of a signal level and a signal quality of at least one beam associated with the communication network, including an indication allowing to determine beams to be measured, and for conducting a validation processing for determining whether a timing advance setting of the communication element or function is valid, wherein the determination is based on the measured metrics and a preset rule related to at least one beams associated with the communication network, and settings for small data transmission indicating resources to be used by the communication element or function for a small data transmission according to a small data transmission mode to be selected according to the validation processing.

Furthermore, according to some other examples of embodiments, the above defined apparatus may further comprise means for conducting at least one of the processing defined in the above described methods, for example a method according to that described in connection with FIG. 6.

According to a further example of embodiments, there is provided, for example, a non-transitory computer readable medium comprising program instructions for causing an apparatus to perform, when used in a communication network element or function configured to act as a communication element or function in a communication network a processing comprising obtaining a first set of metrics indicating at least one of a signal level and a signal quality of at least one beam associated with the communication network, obtaining, before a small data transmission is conducted, a second set of metrics indicating at least one of the signal level and the signal quality of at least one beam associated with the communication network, conducting a validation processing for determining whether a timing advance setting is valid, wherein the determination is based on the measured first set of metrics and the measured second set of metrics and a preset rule related to beams of the at least one beam associated with the communication network, and selecting a small data transmission mode on the basis of a result of the validation processing.

According to a further example of embodiments, there is provided, for example, a non-transitory computer readable medium comprising program instructions for causing an apparatus to perform, when used in a communication network control element or function configured to act as an access network control element or function controlling a communication of a communication element or function in a communication network, a processing comprising preparing and sending, to the communication element or function being served, configuration information of settings for measuring metrics indicating at least one of a signal level and a signal quality of at least one beam associated with the communication network, including an indication allowing to determine beams to be measured, and for conducting a validation processing for determining whether a timing advance setting of the communication element or function is valid, wherein the determination is based on the measured metrics and a preset rule related to at least one beam associated with the communication network, and settings for small data transmission indicating resources to be used by the communication element or function for a small data transmission according to a small data transmission mode to be selected according to the validation processing.

By means of embodiments of the present invention, it is possible to provide a mechanism allowing to evaluate validity of the TA setting based on observations of surrounding (neighbor) beams in addition to the serving beam of the UE. Therefore, the detection of the UE movement is supported, while problematic issues identified above can be overcome.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present disclosure has been described herein before with reference to particular embodiments thereof, the present disclosure is not limited thereto and various modifications can be made thereto.

1-15. (canceled)

16. An apparatus for use by a communication element or function configured to act as a communication element or function in a communication network, the apparatus comprising:
at least one processing circuitry, and
at least one memory for storing instructions to be executed by the processing circuitry,
wherein the at least one memory and the instructions are configured to, with the at least one processing circuitry, cause the apparatus at least to:
obtain a first set of metrics indicating at least one of a signal level and a signal quality of at least one beam associated with the communication network,
obtain, before a small data transmission is conducted, a second set of metrics indicating at least one of a signal level and signal quality of the at least one beam associated with the communication network,
conduct a validation processing for determining whether a timing advance setting is valid, wherein the determination is based on the obtained first set of metrics and the obtained second set of metrics and a preset rule related to the at least one beam associated with the communication network, and
select a small data transmission mode on the basis of a result of the validation processing.

17. The apparatus according to claim 16, wherein the at least one memory and the instructions are further configured to, with the at least one processing circuitry, cause the apparatus at least to:
receive, from an access network control element or function, configuration information of:
settings for obtaining the first set of metrics or the second set of metrics indicating the at least one of the signal level and the signal quality of the at least one beam associated with the communication network, including an indication allowing to determine beams to be measured, and settings for conducting the validation processing, and
settings for small data transmission indicating resources to be used for the small data transmission according to the selected small data transmission mode, and
process the received configuration information.

18. The apparatus according to claim 16, wherein the at least one memory and the instructions are further configured to, with the at least one processing circuitry, cause the apparatus at least to:
store results of the obtaining of the first set of metrics and the second set of metrics indicating the at least one of the signal level and the signal quality of the at least one beam associated with the communication network in association with an identification of the at least one beam being measured.

19. The apparatus according to claim 16, wherein the at least one memory and the instructions are further configured to, with the at least one processing circuitry, cause the apparatus at least to:
obtain, as the first set of metrics, metrics indicating the at least one of the signal level and the signal quality of a serving beam and of non-serving beams, and
obtain, as the second set of metrics, metrics indicating the at least one of the signal level and the signal quality of the serving beam or a default beam and of non-serving beams,
wherein the non-serving beams comprises one of a predetermined number of non-serving beams having the strongest signal strength compared to other non-serving beams, a set of non-serving beams having a signal strength being above a predetermined threshold, a set of non-serving beams being identified by the communication network.

20. The apparatus according to claim 16, wherein the at least one memory and the instructions are further configured to, with the at least one processing circuitry, cause the apparatus at least to:
obtain the first set of metrics indicating the at least one of the signal level and the signal quality of the at least one beam associated with the communication network when the communication element or function is in an inactive radio resource control state having a valid timing advance setting for communicating with a serving access network control element or function.

21. The apparatus according to claim 16, wherein the at least one memory and the instructions are further configured to, with the at least one processing circuitry, cause the apparatus at least to:
select, as the small data transmission mode, a configured grant small data transmission when the result of the validation processing indicates that a valid timing advance setting is present, and
select, as the small data transmission mode, to conduct a random access procedure for the small data transmission when the result of the validation processing indicates that no valid timing advance setting is present.

22. The apparatus according to claim 16, wherein the at least one memory and the instructions are further configured to, with the at least one processing circuitry, cause the apparatus at least to:
check, before obtaining the second set of metrics, whether a signal level or a signal quality of a serving beam fulfills a validity condition for a small data transmission in an inactive connection state, and
conduct, in case the check whether the signal level or signal quality of the serving beam fulfills the validity condition for the small data transmission in the inactive connection state, is negative, a random access procedure for the small data transmission.

23. The apparatus according to claim 16, wherein the first set of metrics or the second set of metrics indicating the at least one of the signal level and the signal quality of the at least one beam associated with the communication network comprises at least one of a reference signal receiving power value and a reference signal receiving quality value obtained for the at least one beam associated with the communication network.

24. The apparatus according to claim 16, wherein the first set of metrics or the second set of metrics indicating the at least one of the signal level and the signal quality of the at least one beam associated with the communication network are at least one of beam related values and cell related values, wherein the values are related to at least one of a serving beam, a default beam and non-serving beams having the strongest signal strength.

25. The apparatus according to claim 16, wherein the preset rule for conducting the validation processing comprises at least one of:
a comparison of identifications of serving beams in the first set of metrics and the second set of metrics,
a comparison of identifications of sets of beams in the first set of metrics and the second set of metrics,
a comparison of variations of obtained metrics of individual beams with a predetermined first threshold,
a comparison of variations of obtained metrics of paired beams with a predetermined second threshold,
a comparison of obtained metrics of non-serving beams with a predetermined third threshold.

26. An apparatus for use by a communication network control element or function configured to act as an access network control element or function controlling a communication of a communication element or function in a communication network, the apparatus comprising:
at least one processing circuitry, and
at least one memory for storing instructions to be executed by the processing circuitry,
wherein the at least one memory and the instructions are configured to, with the at least one processing circuitry, cause the apparatus at least to:
prepare and send, to the communication element or function being served, configuration information of
settings for obtaining metrics indicating at least one of a signal level and a signal quality of at least one beam associated with the communication network, including an indication allowing to determine beams to be measured, and for conducting a validation processing for determining whether a timing advance setting of the communication element or function is valid, wherein the determination is based on the obtained metrics and a preset rule related to the at least one beam associated with the communication network, and
settings for a small data transmission indicating resources to be used by the communication element or function for the small data transmission according to a small data transmission mode to be selected according to the validation processing.

27. A method for use in a communication network element or function configured to act as a communication element or function in a communication network, the method comprising:
obtaining a first set of metrics indicating at least one of a signal level and a signal quality of at least one beam associated with the communication network,
obtaining, before a small data transmission is conducted, a second set of metrics indicating at least one of the signal level and the signal quality of at least one beam associated with the communication network,
conducting a validation processing for determining whether a timing advance setting is valid, wherein the determination is based on the obtained first set of metrics and the obtained second set of metrics and a preset rule related to the at least one beam associated with the communication network, and
selecting a small data transmission mode on the basis of a result of the validation processing.

28. The method according to claim 27, further comprising:
receiving, from an access network control element or function, configuration information of:
settings for obtaining the first set of metrics or the second set of metrics indicating the at least one of the signal level and the signal quality of the at least one beam associated with the communication network, including an indication allowing to determine beams to be measured, and settings for conducting the validation processing, and
settings for a small data transmission indicating resources to be used for the small data transmission according to the selected small data transmission mode, and
processing the received configuration information.

29. The method according to claim 27, further comprising:
obtaining, as the first set of metrics, metrics indicating the at least one of the signal level and the signal quality of a serving beam and of non-serving beams, and
obtaining, as the second set of metrics, metrics indicating the at least one of the signal level and the signal quality of the serving beam or a default beam and of the non-serving beams,
wherein the non-serving beams comprises one of a predetermined number of non-serving beams having the strongest signal strength compared to other non-serving beams, a set of non-serving beams having a signal strength being above a predetermined threshold, a set of non-serving beams being identified by the communication network.

30. The method according to claim 27, further comprising:
obtaining the first set of metrics indicating the at least one of the signal level and the signal quality of the at least one beam associated with the communication network when the communication element or function is in an inactive radio resource control state having a valid timing advance setting for communicating with a serving access network control element or function.

31. The method according to claim 27, further comprising:
selecting, as the small data transmission mode, a configured grant small data transmission when the result of the validation processing indicates that a valid timing advance setting is present, and
selecting, as the small data transmission mode, to conduct a random access procedure for the small data transmission when the result of the validation processing indicates that no valid timing advance setting is present.

32. The method according to claim 27, further comprising:
checking, before obtaining the second set of metrics, whether a signal level or a signal quality of a serving beam fulfills a validity condition for a small data transmission in an inactive connection state, and
conducting, in case the check whether the signal level or signal quality of the serving beam fulfills the validity condition for the small data transmission in the inactive connection state, is negative, a random access procedure for the small data transmission.

33. The method according to claim 27, wherein the first set of metrics or the second set of metrics indicating the at least one of the signal level and the signal quality of the at least one beam associated with the communication network comprises at least one of a reference signal receiving power value and a reference signal receiving quality value obtained for the at least one beam associated with the communication network.

34. The method according to claim 27, wherein the first set of metrics or the second set of metrics indicating the at least one of the signal level and the signal quality of the at least one beam associated with the communication network are at least one of beam related values and cell related values, wherein the values are related to at least one of a serving beam, a default beam and non-serving beams having the strongest signal strength.

35. The method according to claim 27, wherein the preset rule for conducting the validation processing comprises at least one of:
a comparison of identifications of serving beams in the first set of metrics and the second set of metrics,
a comparison of identifications of sets of beams in the first set of metrics and the second set of metrics,
a comparison of variations of obtained metrics of individual beams with a predetermined first threshold,
a comparison of variations of obtained metrics of paired beams with a predetermined second threshold,
a comparison of obtained metrics of non-serving beams with a predetermined third threshold.
